(19) United States
(12) Patent Application Publication
(10) Pub. No.: US 2005/0082389 A1
(43) Pub. Date: Apr. 21, 2005

(54) Methods and apparatus for battery powered hand-held sprayer with remote spray gun assembly

(76) Inventors: Michael J. Sanchez, Des Peres, MO (US); Scott W. Segall, Chesterfield, MO (US); Lance Thibodeaux, Maryland Heights, MO (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(21) Appl. No.: 10/890,872

(22) Filed: Jul. 14, 2004

Related U.S. Application Data
(60) Provisional application No. 60/509,369, filed on Oct. 7, 2003.

(51) Int. Cl. A62C 5/00

(52) U.S. Cl. 239/332; 239/526

(57) ABSTRACT

A hand-held sprayer system includes a hand-held container comprising a body configured to accommodate a quantity of liquid to be dispensed, a hand-held spray gun assembly, and a flexible tube having a predetermined length. The spray gun assembly includes a spray gun body, at least one battery, a pump mechanism, and an actuating element for energizing the pump mechanism with the battery. The tube extends to and between the container and the spay gun assembly, and the tube is in fluid communication with the pump mechanism and in fluid communication with the liquid to be dispensed from the container. The flexible tube is configured for remote positioning of the spray gun assembly from the hand-held container, wherein the spray gun assembly may be positioned relative to the hand-held container at any desired angle and any desired distance up to the predetermined length.

### CROSS REFERENCE TO RELATED APPLICATIONS

This application claims the benefit of U.S. Provisional Patent Application Ser. No. 60/509,369 filed Oct. 7, 2003, which is hereby incorporated by reference in its entirety.

### BACKGROUND OF THE INVENTION

This invention relates generally to powered sprayer devices and, more particularly, to battery powered spray guns for hand-held liquid dispensers.

Conventionally, hand-held liquid dispensers employ manual trigger actuated pump mechanisms for dispensing fluids. The pump mechanism is attached to a bottle holding the liquid to be dispensed, and with one hand a user may hold the bottle and actuate the trigger to dispense liquid from the bottle. While trigger sprayers are convenient for dispensing relatively small amounts of liquid, repetitive actuation of the pump mechanism for dispensing larger amounts of liquid can be cumbersome. For example, when applying liquid insecticides and herbicides, actuating the manual pump a sufficient number of times to treat large areas that are typically treated is undesirable.

Battery powered pump mechanisms have been employed in some hand-held spray bottles to at least partially address the problem of having to repeatedly actuate a manual pump for a desired application. Known battery powered mechanisms for dispensing liquid from a bottle, however, are attached to the bottle in a fixed or stationary relationship to the bottle and are typically integrated into the structure of the cap of the bottle. See, for example, U.S. Pat. Nos. 5,617,007 and 6,554,211. As the bottle increases in size to hold more fluid, such battery powered pumps are disadvantaged. For larger bottles, the bottle can become heavy enough that the average user may have difficulty attempting to both hold the bottle and activate the battery powered pump to dispense the liquid. For example, a desirable amount of insecticide or herbicide for a typical job may require one liter or more of liquid to be sprayed, which is considerably more fluid than many spray dispenser applications require for a given job.

Known battery powered pump mechanisms for hand-held sprayers can also be inconvenient when the batteries are sealed within the housing of the sprayer and generally inaccessible by a user. Rechargeable batteries may be charged for use by patching an electrical adapter into a socket in the sprayer housing and plugging the adapter into an electrical outlet. When the sprayer is used continuously for larger jobs, however, the batteries may need to be frequently charged. The user must discontinue working the sprayer for an adequate time to charge the batteries, prolonging completion of the spraying job.

Pressure sprayers are known which employ air pressure in a closed container to dispense liquid from an attached spray wand. Air is introduced into the containers by manually reciprocating a piston coupled to the top of the container, and pressure in the container forces liquid in the container to be expelled through the wand when the wand is actuated to open a flow path through the wand. While the containers are larger in pressure sprayers to dispense a substantial amount of liquid, it can be a considerable amount of work to use such a pressure sprayer when applying insecticides and herbicides. A filled container of a pressure sprayer may include several gallons of liquid and therefore the container itself can be heavy and cumbersome to carry. Additionally, the container must be frequently pressurized to achieve a uniform spray stream from the wand, and it can be tiresome to hold a handle of the container in one hand and the spray wand in the other when moving about as liquid is dispensed.

Powered spray systems are known which include large tanks for holding fluid to be dispensed, and internal combustion engines which drive a pump or pumps to expel fluid from the tank. Such powered spray systems are typically mounted on wheels and pulled by a vehicle or farm implement. As such, they are typically prohibitively expensive for the average homeowner.

### BRIEF DESCRIPTION OF THE INVENTION

According to an exemplary embodiment of the invention, a hand-held sprayer system is provided. The system comprises a hand-held container comprising a body configured to accommodate a quantity of liquid to be dispensed, a hand-held spray gun assembly, and a flexible tube having a predetermined length. The spray gun assembly comprises a spray gun body, at least one battery, a pump mechanism, and an actuating element for energizing the pump mechanism with the at least one battery. The tube extends to and between the container and the spay gun assembly, and the tube is in fluid communication with the pump mechanism and in fluid communication with the liquid to be dispensed from the container. The flexible tube is configured for remote positioning of the spray gun assembly from the hand-held container, wherein the spray gun assembly may be positioned relative to the hand-held container at any desired angle and any desired distance up to the predetermined length.

According to another exemplary embodiment, a spray gun assembly for a hand-held container of liquid to be dispensed is provided. The spray gun assembly comprises a spray gun body, at least one battery located in the spray gun body, and a pump mechanism disposed within the body in electrical contact with the battery. The pump mechanism comprises an inlet for drawing liquid from the hand-held container and the pump mechanism comprises an outlet. A nozzle assembly is in fluid communication with the pump outlet, and an actuating element is selectively positionable by a user to energize and de-energize the pump mechanism to selectively produce a stream of the liquid to be dispensed at a user determined location remote from the hand-held container.

According to another exemplary embodiment, a container for a hand-held sprayer system having a remotely operable battery powered spray gun assembly is provided. The container comprises a body defining an interior chamber for holding a liquid to be dispensed, and an exterior surface configured to be gripped and held with a single hand of a user, whereby when the body is filled with liquid the body be handled by a user with one hand without aid of a supporting structure while the user's other hand operates the battery powered spray gun assembly. A projection extends outwardly from the body and is configured to detachably mount the battery powered spray gun assembly in a predetermined position relative to the exterior surface.

According to another exemplary embodiment, a hand-held sprayer assembly for a sprayer system having a hand-held container of liquid to be dispensed is provided. The sprayer assembly comprises a spray gun body, a battery powered pump disposed within the spray gun body, an actuator element attached to the spray gun body and selectively positionable to energize the battery powered pump to dispense the liquid to be dispensed, and a flexible tube in fluid communication with the battery powered pump and extending from the spray gun body. The tube is attachable to the hand-held container to pump liquid from the container with the battery powered pump when the spray gun body is held at a remote, user determined, location relative to the hand-held container.

According to another exemplary embodiment, a method of spraying a liquid to be dispensed from a hand-held container with a battery powered spray gun assembly is provided. The spray gun assembly includes a spray gun body, a battery powered pump, and an actuation element for operating the pump. The method comprises connecting the spray gun assembly to the hand-held container with a flexible tube, thereby establishing fluid communication between the battery powered pump and the hand-held container, and actuating the actuation element to operate the pump with a battery, thereby drawing liquid from the hand-held container to the pump and discharging the liquid from the pump at a user determined location relative to the container.

According to still another exemplary embodiment, a method of assembling a hand-held sprayer system is provided. The method comprises providing a hand-held container adapted for holding a liquid to be dispensed; providing a battery powered spray gun assembly having a spray gun body, a battery powered pump, and an actuation element for operating the pump; providing a flexible tube configured to establish fluid communication between the battery powered pump and the hand-held container, and establishing fluid communication between the container and the battery powered spray gun assembly with the flexible tube. The flexible tube extends to and between the container and the spray gun assembly up to a predetermined length, thereby allowing a user to dispense liquid from the container with the battery powered spray gun assembly at a remote location from the container, the spray gun assembly positionable at any angle relative to the container and at any distance relative to the container up to the predetermined length of the tube.

### BRIEF DESCRIPTION OF THE DRAWINGS

FIG. 1 is a side elevational view of a hand-held sprayer system including an exemplary battery powered spray gun assembly.

FIG. 2 is an assembly view of a portion of the system shown in FIG. 1.

FIG. 3 is a broken away view of the spray gun assembly shown in FIGS. 1-3.

FIG. 4 is a bottom end view of the gun assembly shown in FIGS. 1-3 in a closed position.

FIG. 5 is a bottom end view of the gun assembly shown in FIGS. 1-3 in an open position.

FIG. 6 is a partial perspective view of a container and clip assembly for the spray gun assembly shown in FIGS. 2-5.

FIG. 7 is a cross sectional view of the container and clip assembly shown in FIG. 6.

FIG. 8 is another cross sectional view of the container and clip assembly shown in FIG. 6.

FIG. 9 is a flowchart of a method of assembly and spraying for the system shown in FIG. 1.

### DETAILED DESCRIPTION OF THE INVENTION

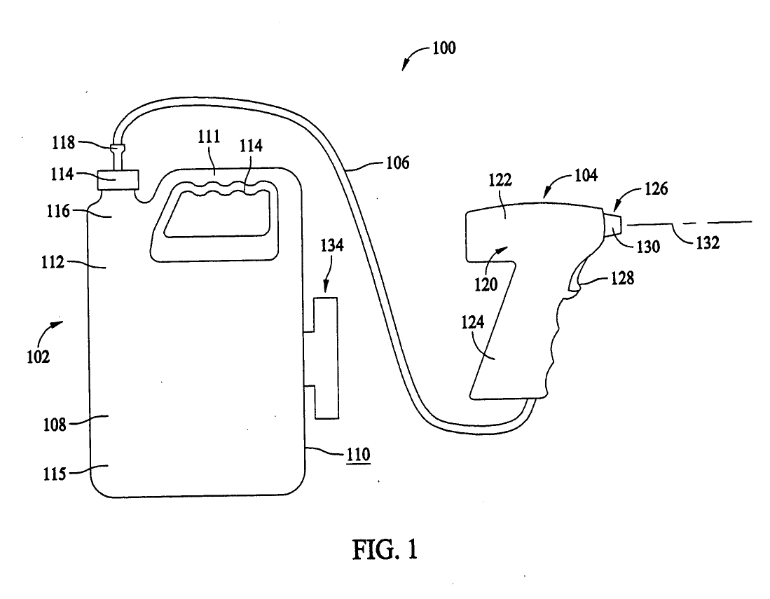

FIG. 1 is a side elevational view of an exemplary hand-held sprayer system 100 including a bottle or container 102 configured for hand-held use and holding a liquid to be dispensed, and an exemplary battery powered spray gun assembly 104. The spray gun assembly 104 and the container 102 are attached to one another with a flexible tube 106 extending therebetween. When the spray gun assembly 104 is operated as described below, fluid is dispensed from the container 102 and discharged from the spray gun assembly 104 via the flexible tube 106.

The container 102 in an exemplary embodiment includes a body 108 having an exterior surface 110 which is substantially rectangular and a hollow interior (not shown in FIG. 1) which is dimensioned to accommodate a predetermined volume of liquid or fluid to be dispensed. In the illustrated embodiment, the container 102 includes a contoured handle portion 111 extending from a top portion 112 of the container 102, and the handle portion 111 includes a handle grip 114 integrally formed therein for accommodating a grip of a user's hand. Thus, the container 102 is sometimes referred to as a hand-held container of a size and weight appropriate for handling by a user without undue strain and without external assistance in the form of a carriage or other supporting structure. While the handle portion 111 is believed to advantageous for certain sizes of the container 102, it is to be understood that the handle portion 111 may be omitted in alternative embodiments and the container may nonetheless be a hand-held container. It is contemplated that the container 102 may have a variety of shapes, sizes, and configurations

A cap 114 is coupled to a neck portion 116 of the container 102 and is sealingly engaged thereto. A dip tube (not shown) is coupled to the cap 114 and extends into the interior of the container 102 to a bottom portion 115 of the container 102. A coupler 118 is connected to the cap 114 and establishes fluid communication with the dip tube in the interior of the container 102. An opposite end of the coupler 118 extends exterior to the cap 114 and establishes fluid communication with the flexible tube 106.

In an exemplary embodiment, the container 102 is formed from heavy duty plastic according to a known molding process, and the container 102 is shaped and dimensioned to hold approximately six liters of fluid. The container 102 is particularly suited for holding a desirable volume of a liquid insecticide or herbicide for spraying or applying to a desired area with the spray gun assembly 104. In a further embodiment, the container is pre-filled with a pre-mixed solution of active ingredients and water so that a user may purchase the container in a substantially usable condition without mixing, filling, or stirring of fluids in the container.

While an exemplary container and fluid have been described, it is recognized that the container 102 may contain a greater or lesser volume of fluid to be dispensed. It is further recognized that a variety of fluids may be dispensed from the container 102, and the system 100 is not intended to be limited to any particular end use and is not limited to any particular fluid, such as an insecticide or herbicide. Rather, the description set forth herein is for illustrative purposes only. The benefits of the system 100 are believed to accrue generally to a wide variety of spraying applications.

In an exemplary embodiment, the spray gun assembly 104 includes a spray gun body 120 which houses a battery powered pump mechanism (not shown in FIG. 1) described further below. The body 120 includes a rounded pump housing portion 122 and a finger grip portion 124 extending from the pump portion 122 at an oblique angle thereto. The pump mechanism is located in the pump housing portion 122 and is in fluid communication with the flexible tube 106 to dispense fluid from the container 102 and discharge the fluid from a nozzle assembly 126 coupled to the pump housing portion 122 of the spray gun body 120. The pump mechanism may be actuated by depressing an actuating element, such as a spring loaded trigger element 128 which is hingedly mounted to the body 120 proximate an intersection of the pump housing portion 122 and the finger grip portion 124 of the spray gun body 120.

The trigger element is pivotally mounted to the spray gun body 120, and depressing of the trigger element 128 with a squeezing motion of a user's ring finger completes an electrical circuit between batteries (not shown in FIG. 1) located within the finger grip portion 124 of the spray gun body 120 and an electric motor (not shown in FIG. 1) located within the pump housing portion 122 of the spray gun body 120. The motor is therefore energized to drive the pump mechanism, also in the pump housing portion 122, to pump fluid from the container 102 through the flexible tube 106 and to the nozzle assembly 126 where the fluid is discharged from the spray gun assembly 104. Continuous spraying of fluid may be accomplished without repetitive actuation of the trigger element by holding the trigger element in an activated position. When the trigger element 128 is released by a user, the spring loaded trigger element returns to a deactivated position wherein electrical contact between the batteries and the motor is broken and the pump mechanism ceases to operate.

In an exemplary embodiment, and in accordance with known nozzle assemblies, a nozzle cap 130 may be provided which is rotatable about an axis 132 to change the manner of discharge of fluid flowing through the nozzle assembly 126. Thus, for example, the nozzle cap 130 may be rotated about the axis 132 in a first or STREAM position to generate a stream of fluid exiting the nozzle assembly 126 in a substantially parallel orientation with respect to the axis 132, a second or SPRAY position generating a fanned spray wherein a portion of the fluid is oriented at a selected angle to the longitudinal axis, or to another position combining the STREAM discharge and the SPRAY discharge from the spray gun assembly 104. Additionally, in a further and/or alternative embodiment, the nozzle cap 130 may be positioned in a CLOSED position wherein no fluid will be dispensed from the nozzle assembly 126.

The flexible tube 106 extends to and between each of the container 102 and the spray gun assembly 104 for a predetermined length and provides flexible positioning of the spray gun assembly 104 relative to the container 102 for dispensing of fluid from the container 102. That is, the spray gun assembly 104 may be positioned at a remote location from the container 102, and the spray gun assembly 104 is operable at any desired angle or location relative to the container 102 as the flexible tube 106 will allow. Unlike known battery powered spray guns for hand-held containers, the spray gun assembly 104 is not fixedly mounted to the container 102, and a user may position the spray gun assembly 104 in any convenient position for use. For example, a user may hold the container 102 in one hand and operate the spray gun assembly 104 with the other hand, or the user may place the container 102 on the ground or other supporting surface while operating the spray gun assembly 104 at a user determined, remote location from the container 102. By virtue of the flexible tube 106, the sprayer system 100 may be conveniently used in a multitude of user selected positions for the convenience and comfort of a user.

It is believed that the combined convenience of a pre-filled container 102 with a carrying handle portion 111, continuous spraying capability with little effort by manipulating the trigger element 128, and remote positioning of the spray gun assembly 104 from the container 102 affords much flexibility and desirability to the sprayer system 100 to appeal to a wide variety of users, and is especially well suited for residential use for lawn and garden maintenance. The system 100 is further believed to be of lower cost than many known alternative sprayer systems for lawn and garden use. At least for these reasons, a cost effective sprayer system 100 is provided which renders spraying jobs for the average homeowner to be more pleasurable, less tiresome, and accomplished more quickly than with known sprayer systems.

Additionally, and in an exemplary embodiment, the system 100 includes a clip 134 attached to the exterior surface 110 of the container 102 on one side thereof as described further below. The clip 134 may be engaged to the spray gun body 120 to hold the spray gun assembly 104 in a fixed position relative to the container 102 for storage when the system 100 is not in use, or when carrying the container 102 to a site for spraying.

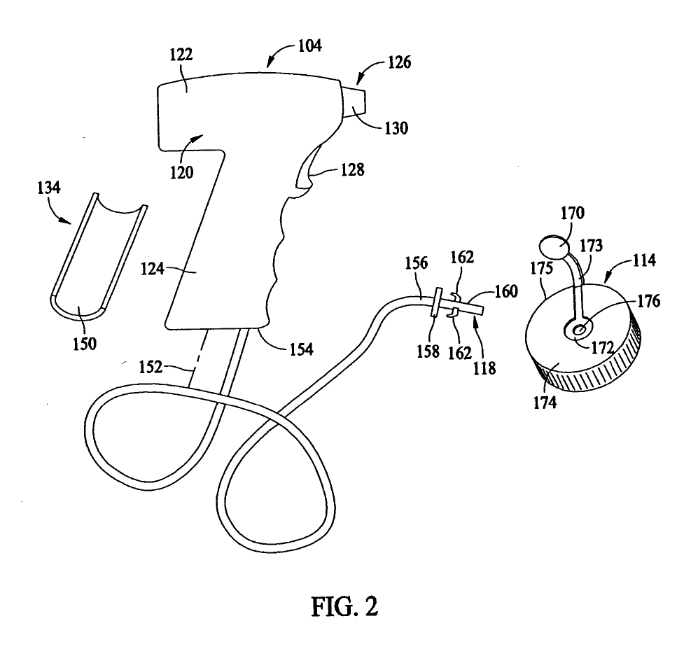

FIG. 2 is an assembly view of a portion of the sprayer system 100 (shown in FIG. 1) including the clip 134, the spray gun assembly 104, and the container cap 114. The clip 134 has a rounded, cup-like body portion 150 which is shaped and dimensioned to receive the finger grip portion 124 of the spray gun body 120 with snap-fit or sliding engagement along a longitudinal axis 152 of the finger grip portion 124. The body portion 150 of the clip 134 wraps around and engages the finger grip portion 124 of the spray gun body generally below the trigger element 128 and extends substantially to a distal end 154 of the finger grip portion 124. In an alternative embodiment, the clip 134 may engage a greater or lesser portion of the finger grip portion 124, or may engage the pump housing portion 122 in lieu of the above described embodiment.

In an exemplary embodiment, the spray gun body 120 is formed from plastic and has two substantially identical halves or body portions (only one of which is shown in FIG. 2) according to a known molding process. The spray gun body portions are fastened together to assemble the spray gun body 120. The flexible tube 106 is coupled to the battery powered pump mechanism (not shown in FIG. 2) at one end thereof, and in an illustrative embodiment the flexible tube 106 extends from the spray gun body 120 at the distal end 154 at a location substantially between the two portions or halves of the body 120. In an illustrative embodiment, the flexible tube 106 extends end-to-end for an axial distance or lineal length of approximately 76.2 cm. In an alternative embodiment, greater or lesser lengths of flexible tube 106 may be employed to vary an operating range of the spray gun assembly 104 relative to the container 102 (shown in FIG. 1).

Additionally, in an exemplary embodiment the flexible tube 106 is extendible from the body 120 and hence may be positioned in an extended position (as shown in FIG. 2) wherein substantially the entire length of the tube 106 extends exterior to the spray gun body 120, or a retracted position wherein substantially the entire length of the tube 106 is positioned interior to the spray gun body 120. The retracted position of the tube 106 is advantageous for shipping and storage purposes.

In an exemplary embodiment, the flexible tube 106 is fabricated from polyvinyl chloride (PVC) according to a known process, and the flexible tube 106 has an inner diameter of approximately 2.0 cm for delivering liquid at a desired flow rate to the spray gun assembly 104. The flexible tube 106 is sufficiently flexible to be easily flexed to a desired operation position, yet structurally capable of withstanding pressure conditions of fluid passing through the tube 106 in operation. It is contemplated that other flexible materials in lieu of those described above may be employed in further and/or alternative embodiments of the flexible tube, and it is further understood that greater or lesser diameters of tubing may be employed in alternative embodiments of the invention as desired to achieve specific flow rate objectives and applicable specifications for dispensing of particular fluids.

The coupler 118 is sealingly coupled to an end 156 of the flexible tube 106, and in one embodiment the coupler 118 includes a sealing rim 158, a shaft 160, and retention prongs 162. The shaft 160 includes a fluid passage (not shown) therein to establish fluid communication between the flexible tube 106 and a dip tube (not shown) which is coupled to the cap 114, or alternatively to the container 102 (shown in FIG. 1) in fluid communication with an interior of the container 102.

As illustrated in FIG. 2, the cap 114 includes a hinged lid 170 and a complementary recess 172 in a top surface 174 of the cap 114. The lid 170 is positionable in closed position wherein the lid 170 substantially occupies the recess 172, and an open position (shown in FIG. 2) wherein the lid 170 is pivoted about an end 173 thereof adjacent an outer periphery 175 of the cap top surface 174 such that the lid 170 is positioned to provide clear access to the recess 172. An opening 176 extends through a center portion of the cap 114 and is substantially centered in the recess 172, and the shaft 160 of the coupler 118 is insertable through the opening 176 until the prongs 162 clear the opening and permanently lock the coupler 118 to the cap 114 with the rim 158 of the coupler 118 seated in a portion of the recess 172 adjacent the opening 176 to seal the fluid passage. When the cap 118 is coupled to the container 102 (shown in FIG. 1) and the shaft 160 is coupled to a dip tube, the trigger element 128 of the spray gun assembly 104 may be actuated to pump fluid from the container through the nozzle assembly 126.

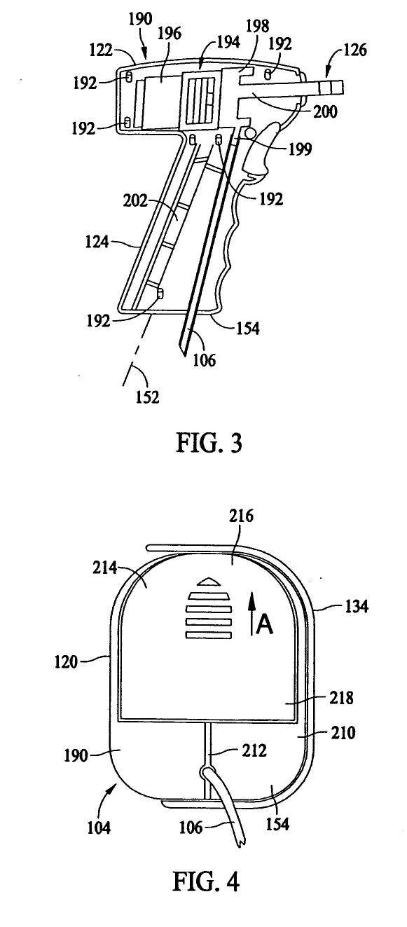

FIG. 3 is a plan view of an exemplary body portion 190 which may be employed with a substantially identical, mirror image body portion (not shown in FIG. 3) to form the spray gun body 120 (shown in FIGS. 1 and 2). The body portion 190 is formed into a pump housing portion 122, a finger grip portion 124, and a number of mounting formations 192 which may accept, for example, a known threaded fastener (not shown) to secure the body portion 190 to a mating body portion to complete the spray gun body 120.

A battery powered pump mechanism 194 is secured within the pump housing portion 122, and the pump mechanism 194 includes an electric motor 196 and a pump 198 engaged to the motor 196. A motor output shaft (not shown) is engaged to the pump 198 in a driving relationship to draw liquid from a pump inlet 199 and to expel the liquid from a pump outlet 200. The pump inlet 199 is coupled to the flexible tube 106, and the flexible tube 106 extends downward from the pump inlet 199 through the finger grip portion 124 to the distal end 154, and then exterior to the body portion 190 wherein the tube 106 may be coupled to the container 102 (shown in FIG. 1) in the manner described above. The pump outlet 200 is coupled to the nozzle assembly 126, and when the nozzle cap 130 (shown in FIGS. 1 and 2) is attached thereto, the fluid discharge may be adjusted from, for example, a stream discharge to a spray discharge, as described above.

The finger grip portion 124 of the body portion 190 defines a longitudinally extending battery compartment 202 extending substantially parallel to the axis 152 of the finger grip portion 124. The battery compartment 202 is shaped and dimensioned to receive two “AA” size batteries (not shown in FIG. 3) end-to-end. Thus, considering that there are two body portions 190 which form the spray gun body 120, four “AA” batteries power the motor 196 and the pump 198. As such, the batteries supply sufficient power or energy to pump at least about 1.5 gallons of fluid, or approximately the volume of the container 102 (shown in FIG. 1), without exhausting the batteries. It is understood, however, that greater of fewer numbers of batteries, and other sizes of batteries, may alternatively be used to pump more or less fluid. The batteries may be lithium batteries, alkaline batteries, and the like as those in the art will appreciate.

Battery contacts (not shown) are located at each end of the battery compartment, and the respective battery contacts are electrically connected to switch contacts (not shown) associated with the trigger element 128. When the trigger element 128 is depressed, the switch contacts close a circuit through the batteries, and the batteries energize the motor 196 to operate the pump mechanism 194 to dispense fluid from the container 102. When the trigger element 128 is released, the switch contacts are separated, the circuit through the batteries is opened, and the motor 196 ceases to operate the pump mechanism 194. Thus, a user may selectively position the trigger element 128 between activated and deactivated positions to open and close the circuit through the batteries and initiate or cease dispensing of liquid from the container 102 (shown in FIG. 1)

In an exemplary embodiment, the motor 196 is a 6.0 V D.C. electric motor having a no load speed of 15,000 rpm, a stall current of about 6 A, a stall torque of about 152 g-cm, and a no load current of about 0.26 A maximum. One such suitable motor is a model RC-260SA-3071 1A-2 motor available from Kam Tai of Shenzhen, China. It is recognized, however, that other motors may be used in alternative embodiments without departing from the scope and spirit of the invention.

In an exemplary embodiment, the pump 198 is a known gear pump mechanism adapted to provide a desired flow rate, for example, for spraying an insecticide, herbicide, or other liquid when actuated by the motor 196, and to achieve an adequate pressure to generate a spray or stream at a specified distance from the nozzle assembly 126 in use That is, the pump 198 is capable of generating a stream or spray of liquid to reach an intended object to be treated when the spray gun body 120 is located at a specified distance from the object. By way of example only, in one embodiment, the pump 198 delivers a minimum of 40 grams of liquid in 17 seconds, is capable of generating sufficient pressure to produce a stream of liquid at least distance of 15 feet from the nozzle, and spray at least 1.5 gallons of liquid from the container at a sufficient rate to complete a spraying job in a reasonable amount of time. Additionally, the pump generates sufficient pressure to achieve variable degrees of spray patterns as the nozzle 126 is turned from CLOSE to SPRAY or STREAM positions.

FIG. 4 is a bottom end view of the spray gun assembly 104 at the distal end 154 illustrating the first body portion 190 and a second body portion 210 secured to the first body portion to complete the spray gun body 120 (shown in FIGS. 1 and 2). The flexible tube 106 extends from the spray gun assembly 104 between a seam 212 formed between the body portions 190 and 210.

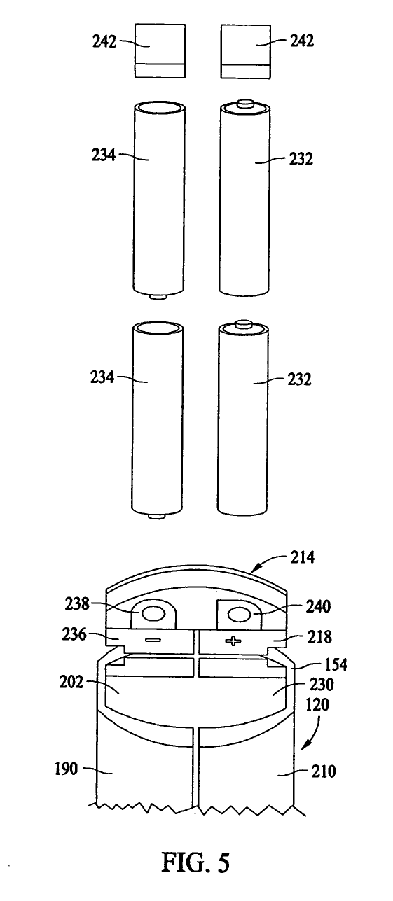

A battery access door 214 is attached to the first and second body portions 190 and 210 for access to the battery compartments 202, 230 (shown in FIG. 5) defined in the body portions 190, 210 underneath the access door 214. A forward end 216 of the access door 214 is rounded to complement the outer profile of the spray gun body 120, and a rear end 218 of the access door 214 is hinged to allow the door to pivot about the rear end 218 and swing outward and away from the distal end 154 of the spray gun body 120 to provide access to the battery compartments for removal and replacement of the batteries. In an illustrative embodiment, the battery access door 214 is moved laterally in the direction of arrow A before opening on the hinge and providing access to the battery compartments. In other words, the door 214 is opened with two-step actuation, namely a linear sliding movement in the direction of arrow A and a pivoting or swinging movement about the hinged end. The door 214 does not include external fasteners, such as screws, and the door 214 may be opened by hand without the use of tools, such as a screwdriver.

Additionally, and as illustrated in FIG. 4, the clip 134 is engaged to the distal end 154 of the spray gun body 120 with snap fit engagement, and the clip 134 wraps around the spray gun body 120 on three sides thereof to cradle the spray gun body. As illustrated in FIG. 4, the wrap-around clip 134 prevents actuation of the battery access door 214 in the direction of arrow A when the spray gun body 120 is engaged to the clip 134. Thus, the batteries may not be accessed when the spray gun body is engaged to the clip 134. The batteries may therefore be protected from theft during shipping and handling of the sprayer system 100 (shown in FIG. 1).

FIG. 5 illustrates the spray gun body 120 with the battery access door 214 in an open position about the hinged rear end. In the open position, the access door 214 is positioned out of the way of the distal end 154 such that the battery compartment 202 of the first body portion 190 and the battery compartment 230 of the second body portion 210 are accessible for convenient installation and removal of the batteries therein. More specifically, pairs of batteries 232 and 234 may be inserted into the compartments 202 and 230, respectively in an end-to-end configuration with the positive and negative terminals of the batteries 232 and 234 oriented appropriately for completing an electrical circuit in the spray gun assembly 104 (shown in FIGS. 1-3). To assist a user in loading the batteries 232 and 234, positive and negative terminal indicia are indicated on an inner surface 236 of the battery access door 214. Battery contacts 238 and 240 are also mounted to the inner surface 236 of the battery access door. The battery contacts 238 and 240 urge the batteries 232 and 234 into contact with spring loaded battery contacts (not shown) at an opposite end of the battery compartments 202 and 230 in the spray gun body 120 to ensure electrical contact between the battery terminals with one another in the battery pairs 232 and 234 and also in contact with the battery contact at respective ends of the battery compartments 202 and 232 when the access door 214 is closed. Once installed, the batteries 232 and 234 are located proximate the access door 214 so that when the access door 214 is opened, the batteries 232 and 234 are readily accessible and may be removed from the spray gun body 120.

Additionally, insulative (i.e., nonconductive) isolation tabs 242 are provided on an end of each of the batteries 232 and 234 proximate the battery access door 214. The isolation tabs 242 prevent electrical contact with the battery terminals and completion of an electrical circuit through the batteries 232 and 234. The spray gun body 120 may therefore be loaded and shipped with the batteries 232 and 234 installed, and the purchasing user need only remove the isolation tabs 242 to commence spraying operation. In one embodiment, the isolation tabs 242 may be fabricated from plastic materials according to known processes and techniques.

Still further, in an exemplary embodiment, the battery access door 214 includes features to prevent the door 214 from closing if the batteries are not properly installed. For example, if the batteries 232 and 234 are oriented upside down in the battery compartments 202, 238, a rib or projection may be provided which interferes with the batteries and prevents closing of the door 214. When the batteries 232, 234 are properly oriented and installed, however, the door 214 does not interfere with the batteries and the door 214 may be closed.

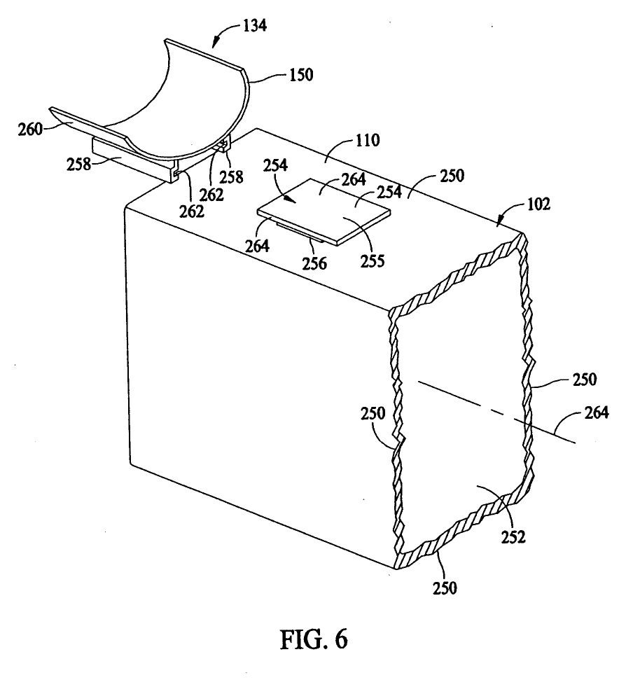

FIG. 6 is a partial perspective view of the container 102 and clip 134 for the spray gun assembly 104 (shown in FIGS. 1-5). The container 102 in an exemplary embodiment includes four side walls 250 collectively defining an interior chamber 252 for storing a volume of liquid. While the container side walls 252 are illustrated in a substantially rectangular configuration, it is recognized that any configuration or shape of side walls may be employed in various different containers. Additionally, more or less than four walls may be employed to fabricate the container 102, and the side walls may be of a curved or contoured configuration in lieu of the illustrated substantially flat side walls.

A clip mounting element 254 projects outwardly from an external surface 110 of one of the side walls 150 of the container 102. The mounting element 254 includes a plate-like runner 255 extending atop a footing 256 which is recessed on the lateral sides thereof relative to the runner 255. That is, the runner 255 overhangs the footing 256. The footing 256 is fixedly mounted to the side wall 150 and extends upward from the exterior surface 110 of the side wall 150, and the runner 255 extends upward from the footing 256 such that the footing 256 is positioned between the runner 255 and the exterior surface 110.

The clip 134 includes the channel-like body portion 150 described above and connecting rails 258 extending downward from an exterior surface 260 of the body portion 258. The rails 258 include inwardly facing grooves 262 which form a channel therebetween to receive the lateral side edges 264 of the runner 255 with sliding engagement. A frictional interference fit maintains the clip rails 258 to the runner 255 in one embodiment, or alternatively, a locking protrusion or feature could be formed in one of the clip 134 and the container 102 to secure the clip 134 to the container 102 in a desired position. As illustrated in FIG. 6, the runner 255 is oriented at an angle to a longitudinal axis 264 extending through the container 102, and thus the spray gun body 120 is oriented at an angle to the longitudinal axis 264 when the body portion 150 of the clip 134 is engaged to the spray gun body 120.

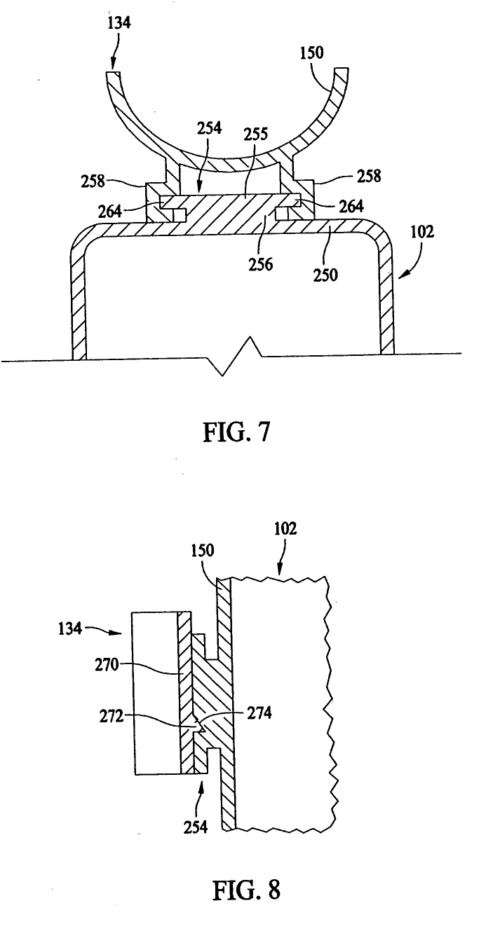

FIG. 7 is a cross sectional view of the container 102 and clip 134 further illustrating the engagement of the clip 134 to the mounting element 254, or more specifically the engagement of the rails 258 to the runner 255. The lateral edges 264 of the runner 255 are received in the grooves 262 (shown in FIG. 6) of the rails 258. The body 150 of the clip 134 extends above the rails 264 and the runner 255 so that the gun assembly 104 (shown in FIGS. 1-5) may be engaged thereto as desired.

In an exemplary embodiment, the clip body portion 150 and the rails 258 are integrally formed from a known plastic material to fabricate the clip 134. It is recognized, however, that the rails 258 could be separately provided and otherwise attached to the body portion 150 to manufacture the clip 134.

As also illustrated in FIG. 7, in an exemplary embodiment the footing 256 and the runner 255 of the mounting element 254 are integrally formed into the sidewall 250 such as by a known molding operation. In an alternative embodiment, the mounting element 254 may be separately provided and affixed to the container 254 according to known fastening techniques.

FIG. 8 is another cross sectional view of the container 102 and clip 134 attached thereto in a further embodiment of the invention. The clip mount 254 extends outward from the side wall 250 of the container 102, and a bottom 270 of the clip 134 includes a locking projection 272 extending outward therefrom and facing toward the clip mount 254 of the container 102. The locking projection is received in a complementary opening 274 in the clip mount 254, thereby locking the clip 134 to the clip mount 254. It is recognized that in alternative embodiments a locking projection may be formed in the clip mount 254 and a locking opening may be provided in the clip 134 to achieve substantially a similar locking effect. While in the illustrated embodiment, the lock projection 272 is substantially triangular in shape, it is recognized that other shapes and configurations of locking surfaces may be alternatively employed in other embodiments of the invention.

Having described one exemplary clip 134 and mounting element 254, it is understood that those in the art may employ a wide variety of alternative clip configurations and mounting features to secure a clip to the container 102. The clip 134 is therefore described for illustrative purposes only.

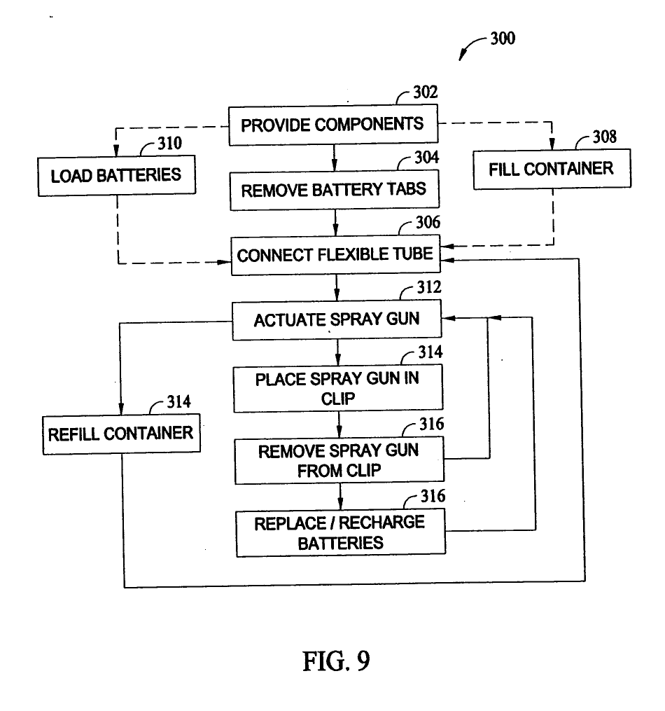

FIG. 9 illustrates a method of assembly and spraying 300 for the system 100 (shown in FIG. 1) wherein a liquid to be dispensed from a hand held container 102 (shown in FIG. 1) may be sprayed with the spray gun assembly 104 (shown in FIG. 1).

First, the components of the hand held sprayer system 100 (FIG. 1) are provided 302. That is, the container 102, the spray gun assembly 104, the flexible tube 106, and the clip 134 are provided 302 to a user. In an exemplary embodiment, all the components are provided 302 in a package at a point of sale, although it is appreciated that the components may be separately provided in other embodiments.

In exemplary embodiments as described above, the components are provided 302 generally in a ready-to-use manner wherein the container 102 is pre-filled with a liquid to be dispensed (e.g., a herbicide or insecticide), the flexible tube 106 is attached to the spray-gun assembly, and the spray gun assembly 104 is pre-loaded with batteries 232 and 234 (FIG. 5) and battery isolation tabs 242 (FIG. 5). In such a case, the user need only remove 304 the battery tabs and connect 306 the flexible tube 106 to the container 102 to commence spraying. Optionally, and in alternative embodiments, the container may be filled 308 with, for example, a liquid insecticide or herbicide solution, by the user after the components are provided. Additionally, any batteries needed to power the spray gun assembly may optionally be loaded 310 in the spray gun assembly by the user after the components are provided 302.

The flexible tube 106 may, for example, be connected 306 to the spray gun assembly 104 and to the container 102 in the manner described above (e.g., with the cap 114 and the coupler 118 shown in FIGS. 1 and 2). Alternatively, the tube 106 may be connected 306 in another manner, provided only that fluid communication is established between the liquid in the container 102 and the pump mechanism 194 (FIG. 3) wherein the pump mechanism 194 may draw the liquid from the container 102 when activated.

Once the tube 106 has been connected 306, spraying may commence by actuating 312 the spray gun assembly to operate the battery powered pump mechanism 194. As noted above, spray gun assembly is actuated in a user determined location remote from the container 102, and thus, for example, the container 102 may be held by the user with one hand and the spray fun assembly 104 may be actuated in the other hand. In the illustrated embodiment, the trigger element 128 is actuated with the user's ring finger to close a circuit through the batteries 232, 234 and operate the pump mechanism 194. It is appreciated, however, the other actuation elements may be employed, including but not limited to a button or slide actuator which may be manipulated, for example, with the user's thumb.

After actuating 312 the spray gun assembly 104 to dispense a desired amount of liquid from the container 102, the spray gun assembly 104 may be placed 314 in the clip 134 attached to the container 102, and the clip 104 conveniently maintains the spray gun assembly 104 proximate to the container 102. When so used, the clip 134 prevents the spray gun assembly 104 from being inadvertently lost, misplaced, or damaged when not is use. Additionally, when the spray gun assembly 104 is engaged to the clip 134, the trigger element 128 may not be actuated to dispense liquid, thereby preventing an inadvertent spray of liquid.

The spray gun assembly 104 may be removed 316 from the clip 134 to resume actuation 312 of the spray gun assembly 104 for further spraying. Actuation 312 may continue until the batteries are exhausted or until the container 102 is emptied. Thus, the container may be refilled 314, and the batteries may be recharged or replaced 316, depending upon the type of batteries used.

Thus, the hand-held sprayer system 100 provides convenient spraying with minimal effort by a user. Especially for jobs like lawn and garden maintenance, the sprayer system 100 may reduce an amount of time needed to complete the job, and make the duration of the job more enjoyable. The advantages of powered sprayer systems are realized at a comparably low cost, and the hand-held system is more amenable to purchase, use, and storage by the average homeowner than many known sprayer systems.

While the invention has been described in terms of various specific embodiments, those skilled in the art will recognize that the invention can be practiced with modification within the spirit and scope of the claims.

1. A hand-held sprayer system comprising:
a hand-held container comprising a body configured to accommodate a quantity of liquid to be dispensed;
a hand-held spray gun assembly comprising a spray gun body, at least one battery, a pump mechanism, and an actuating element for energizing said pump mechanism with said at least one battery; and
a flexible tube having a predetermined length, said tube extending to and between said container and said spay gun assembly, said tube in fluid communication with said pump mechanism and in fluid communication with said liquid to be dispensed from said container, said flexible tube configured for remote positioning of said spray gun assembly from said hand-held container, wherein said spray gun assembly may be positioned relative to said hand-held container at any desired angle and any desired distance up to said predetermined length.

2. A hand-held sprayer system in accordance with claim 1 further comprising a coupler at an end of said flexible tube opposite said pump mechanism, said coupler configured for sealed engagement with said container.

3. A hand-held sprayer system in accordance with claim 1 further comprising a cap sealingly attachable to said container, said flexible tube coupled to said cap to establish fluid communication with said container.

4. A hand-held sprayer system in accordance with claim 1 wherein said spray gun body comprises a finger grip portion, and said actuation element comprises a trigger element pivotally mounted to said spray gun body.

5. A hand-held sprayer system in accordance with claim 1 wherein said spray gun body comprises a battery access door positionable between open and closed positions, said at least one battery disposed within said spray gun body and located proximate said battery access door.

6. A hand-held sprayer system in accordance with claim 5 wherein said battery access door is positionable between the open and closed position by hand without using tools.

7. A hand-held sprayer system in accordance with claim 5 wherein said battery access door is hinged at one end.

8. A hand-held sprayer system in accordance with claim 1 wherein said body of said hand-held container comprises a handle portion.

9. A hand-held sprayer system in accordance with claim 1 wherein said body of said hand-held container comprises side walls defining a substantially rectangular interior chamber holding said liquid to be dispensed.

10. A hand-held sprayer system in accordance with claim 1 further comprising a clip configured to engage and hold said spray gun assembly in a fixed position relative to said hand-held container.

11. A hand-held sprayer system in accordance with claim 10 wherein said clip is configured for locking engagement to said container.

12. A hand-held sprayer system in accordance with claim 10 wherein said clip comprises a channel configured to receive a portion of the container.

13. A hand-held sprayer system in accordance with claim 1 wherein said spray gun body comprises first and second body portions, each of said body portions defining a battery compartment, and said at least one battery located in said battery compartment.

14. A hand-held sprayer system in accordance with claim 13 wherein each battery compartment is configured to receive a pair of batteries end to end.

15. A hand-held sprayer system in accordance with claim 1 further comprising at least one battery isolation tab proximate said battery, said battery isolation tab removable by a user to establish electrical connection between said at least one battery and said pump mechanism when said actuation element is actuated.

16. A hand-held sprayer system in accordance with claim 1 wherein said spray gun assembly comprises a nozzle assembly, said nozzle assembly adjustable to vary an output stream of liquid from said pump mechanism.

17. A spray gun assembly for a hand-held container of liquid to be dispensed, said spray gun assembly comprising:
a spray gun body;
at least one battery located in said spray gun body;
a pump mechanism disposed within said body in electrical contact with said battery, said pump mechanism comprising an inlet for drawing liquid from the hand-held container and said pump mechanism comprising an outlet;
a nozzle assembly in fluid communication with said pump outlet; and
an actuating element selectively positionable by a user to energize and de-energize said pump mechanism to selectively produce a stream of the liquid to be dispensed at a user determined location remote from the hand-held container.

18. A spray gun assembly in accordance with claim 17 wherein said spray gun body defines a battery compartment, said battery located in said battery compartment.

19. A spray gun assembly in accordance with claim 17 wherein said battery compartment is configured to receive at least two batteries end-to-end.

20. A spray gun assembly in accordance with claim 17 wherein said spray gun body comprises a battery access door, said at least one battery removable through said battery access door.

21. A spray gun assembly in accordance with claim 17 wherein said battery access door is hinged at one end.

22. A spray gun assembly in accordance with claim 17 wherein said spray gun body comprises first and second body portions, each of said body portions defining a battery compartment.

23. A spray gun assembly in accordance with claim 17 wherein said spray gun body comprises a finger grip portion and said actuation element comprises a pivotally mounted trigger adjacent said finger grip portion.

24. A spray gun assembly in accordance with claim 17 further comprising at least one battery isolation tab preventing electrical connection between said battery and said pump mechanism, said tab removable by a user to establish an electrical connection between said battery and said pump when said actuation element is actuated.

25. A container for a hand-held sprayer system having a remotely operable battery powered spray gun assembly, said container comprising:
a body defining an interior chamber for holding a liquid to be dispensed, and an exterior surface configured to be gripped and held with a single hand of a user, whereby when said body is filled with liquid the body be handled by a user with one hand without aid of a supporting structure while the user's other hand operates the battery powered spray gun assembly; and
a projection extending outwardly from said body and configured to detachably mount the battery powered spray gun assembly in a predetermined position relative to said exterior surface.

26. A container in accordance with claim 25 wherein said container is adapted to contain about 1.5 gallons of liquid.

27. A container in accordance with claim 25 wherein said container comprises a handle portion.

28. A container in accordance with claim 25 wherein said body comprises side walls defining a substantially rectangular interior.

29. A container in accordance with claim 25 wherein said interior chamber is filled with a liquid insecticide or herbicide.

30. A container in accordance with claim 25 wherein said projection comprises a footing and a runner overhanging said footing.

31. A container in accordance with claim 25 wherein said runner is oriented at an angle with respect to a longitudinal axis of said container.

32. A container in accordance with claim 25 further comprising a clip configured to engage the battery powered spray gun assembly, said clip including at least one mounting rail, said projection configured for slidably mounting the clip via the mounting rail.

33. A container in accordance with claim 25 further comprising a clip configured to engage the battery powered spray gun assembly, wherein said projection comprises at least one of a locking tab and a lock opening configured for locking engagement with the clip.

34. A container in accordance with claim 25, wherein said projection is substantially rectangular.

35. A container in accordance with claim 25 wherein said projection comprises an engagement portion having lateral edges which are spaced from said exterior surface of said body and elevated with respect to said exterior surface, said lateral edges configured to engage a clip which receives the battery powered spray gun assembly.

36. A container in accordance with claim 31 wherein said projection includes a first portion extending from said body, and a second portion extending from said first portion, said first portion recessed relative to said second portion to define a clearance between said second portion and said exterior surface of said body.

37. A hand-held sprayer assembly for a sprayer system having a hand-held container of liquid to be dispensed, said sprayer assembly comprising:
a spray gun body;
a battery powered pump disposed within said spray gun body;
an actuator element attached to said spray gun body and selectively positionable to energize said battery powered pump to dispense the liquid to be dispensed; and
a flexible tube in fluid communication with said battery powered pump and extending from said spray gun body, said tube attachable to the hand-held container to pump liquid from the container with the battery powered pump when the spray gun body is held at a remote, user determined, location relative to the hand-held container.

38. A hand-held sprayer assembly in accordance with claim 37 further comprising a clip configured to engage said spray gun body, said clip attachable to said spray gun body to maintain said spray gun body in a fixed position relative to said container.

39. A spray gun assembly in accordance with claim 37 wherein said clip comprises a channel, said channel configured to receive a portion of said container.

40. A spray gun assembly in accordance with claim 37 wherein said spray gun body comprises a battery access door.

41. A spray gun assembly in accordance with claim 37 further comprising a coupler attached to said flexible tube, said coupler configured to establish fluid communication with the container.

42. A method of spraying a liquid to be dispensed from a hand-held container with a battery powered spray gun assembly, the spray gun assembly including a spray gun body, a battery powered pump, and an actuation element for operating the pump, said method comprising:
connecting the spray gun assembly to the hand-held container with a flexible tube, thereby establishing fluid communication between the battery powered pump and the hand-held container; and
actuating the actuation element to operate the pump with a battery, thereby drawing liquid from the hand-held container to the pump and discharging the liquid from the pump at a user determined location relative to the container.

43. A method in accordance with claim 42 wherein the container includes a cap, said method comprising coupling the flexible tube to the cap.

44. A method in accordance with claim 42, the spray gun assembly including at least one battery isolation tab, said method further comprising removing the at least one isolation tab.

45. A method in accordance with claim 42 further comprising:
holding the hand-held container in one hand; and
operating the battery powered spray gun assembly with another hand.

46. A method in accordance with claim 42, the hand-held container including a clip mounted to the container, said method comprising:
removing the spray gun assembly from the clip;
spraying a desired amount of liquid to be dispensed with the spray gun assembly; and
returning the spray gun assembly to the clip.

47. A method in accordance with claim 42 further comprising filling the hand-held container with a liquid insecticide or herbicide solution.

48. A method of assembling a hand-held sprayer system, said method comprising:
providing a hand-held container adapted for holding a liquid to be dispensed;
providing a battery powered spray gun assembly having a spray gun body, a battery powered pump, and an actuation element for operating the pump;
providing a flexible tube configured to establish fluid communication between the battery powered pump and the hand-held container, and
establishing fluid communication between the container and the battery powered spray gun assembly with the flexible tube, the flexible tube extending to and between the container and the spray gun assembly up to a predetermined length, thereby allowing a user to dispense liquid from the container with the battery powered spray gun assembly at remote location from the container, the spray gun assembly positionable at any angle relative to the container and at any distance relative to the container up to the predetermined length of the tube.

49. A method in accordance with claim 48 wherein providing a hand-held container comprises providing a sealed container which is pre-filled with liquid to be dispensed.

50. A method in accordance with claim 48 wherein the spray gun body includes a battery compartment, said providing a battery powered spray gun comprises pre-loading at least one battery in the battery compartment.

51. A method in accordance with claim 48 further comprising providing a clip which is configured to be mounted to the container and which is configured to receive a portion of the spray gun assembly.

52. A method in accordance with claim 51 further comprising attaching the clip to an exterior surface of the container.

53. A method in accordance with claim 52 further comprising engaging the spray gun assembly to the clip.

54. A method in accordance with claim 48 further comprising providing a coupler configured to connect the tube to the container, and connecting the tube to the container with the coupler.

55. A method in accordance with claim 53 further comprising providing a cap for the container, the cap configured for connection to the flexible tube.

56. A method in accordance with claim 48 wherein providing a flexible tube comprises providing a flexible tube pre-attached to the battery powered spray gun assembly in fluid communication with the battery powered pump.
